(19) United States
(12) Patent Application Publication
(10) Pub. No.: US 2009/0038173 A1
(43) Pub. Date: Feb. 12, 2009

(54) CLOTHES DRIER

(76) Inventors: Seung-Phyo AHN, Changwon (KR); Sang-Ik Lee, Changwon (KR); Byeong-Jo Ryoo, Changwon (KR); Sung-Ho Song, Changwon (KR); Jeong-Yun Kim, Changwon (KR); Yang-Hwan Kim, Changwon (KR); Jae-Hyuk Wee, Changwon (KR); Dong-Hyun Kim, Changwon (KR); Yoon-Seob Eom, Changwon (KR); Yang-Ho Kim, Changwon (KR)

Correspondence Address: KED & ASSOCIATES, LLP, P.O. Box 221200, Chantilly, VA, 20153-1200, US

(21) Appl. No.: 12/183,226

(22) Filed: Jul. 31, 2008

(30) Foreign Application Priority Data
Aug. 6, 2007 (KR) 10-2007-0078738

(51) Int. Cl. F26B 25/00; F26B 11/02

(52) U.S. Cl. 34/74; 34/130

(57) ABSTRACT

A clothes drier comprises: a body; a drum rotatably installed at the body; a hot air supply unit configured to supply hot air into the drum; a heat exchanger configured to dehumidify air exhausted from the drum; a pipe unit configured to supply water to the heat exchanger and collect water from the heat exchanger; and a freeze damage preventing unit installed on the pipe unit. The clothes drier is provided with the freeze damage preventing unit configured to partially or completely discharge out water remaining in the heat exchanger after the clothes drier is stopped. Accordingly, freeze damage of the heat exchanger during winter time is prevented.

### RELATED APPLICATION

The present invention relates to subject matter contained in priority Korean Application No. 10-2007-0078738, filed on Aug. 6, 2007, which is herein expressly incorporated by reference in its entirety.

### BACKGROUND OF THE INVENTION

1. Field of the Invention

The present invention relates to a clothes drier, and more particularly, to a clothes drier having a heat exchanger that removes moisture inside air exhausted from a drum in a water-cooled manner.

2. Description of the Background Art

Generally, a clothes drier serves to dry clothes by blowing hot air into a drum and thereby absorbing moisture inside the clothes. The clothes drier may be largely classified into an exhausting type, a condensing type, and a ductless type according to a processing method for air occurring when clothes are dried.

The condensing type clothes drier and the ductless type clothes drier include a heat exchanger configured to dehumidify air exhausted from a drum. Water is supplied to the heat exchanger so that moisture inside air passing through the heat exchanger can be removed in a water-cooled manner. As water supplied to the heat exchanger performs heat exchange with air passing through the heat exchanger, moisture inside the air is removed. This type of heat exchanger is called as a water-cooled type heat exchanger.

During winter time, when the condensing type clothes drier or the ductless type clothes drier are stopped, water supplied to the heat exchanger remains in the heat exchanger.

The water remaining in the heat exchanger is cooled by a low temperature thus to become ice with an expanded volume. Here, the expanded volume is larger than the original volume by approximately 20%. In order to manage the expanded volume, an empty space corresponding to 100% or 30% of the heat exchanger has to be obtained whenever a driving step is ended.

However, in the conventional condensing type or ductless type clothes drier each having a water-cooled type heat exchanger, water remaining in the heat exchanger is not discharged out when a driving step is ended, but remains in the heat exchanger. Accordingly, an empty space in preparation for an expanded volume of water occurring when the water becomes ice is not obtained in the heat exchanger. As a result, the heat exchanger has freeze damage due to the expanded volume. This causes the water-cooled type clothes drier to have a degraded reliability, resulting in a user's inconvenience and necessity of A/S.

### SUMMARY OF THE INVENTION

Therefore, it is an object of the present invention to provide a clothes drier having a water-cooled type heat exchanger that removes moisture inside air exhausted from a drum, capable of protecting the heat exchanger from freeze damage.

To achieve these and other advantages and in accordance with the purpose of the present invention, as embodied and broadly described herein, there is provided a clothes drier, comprising: a body; a drum rotatably installed at the body; a hot air supply unit configured to supply hot air into the drum; a heat exchanger configured to dehumidify air exhausted from the drum; a pipe unit configured to supply water to the heat exchanger and collect water from the heat exchanger; and a freeze damage preventing unit installed on the pipe unit.

Preferably, the pipe unit includes a water supply pipe configured to supply water to the heat exchanger; a water collect pipe configured to collect water from the heat exchanger, and a supply valve configured to open and close the water supply pipe.

Preferably, the freeze damage preventing unit includes a first drain pipe diverged from the water supply pipe, and a first valve configured to open and close the first drain pipe.

Preferably, for smooth drain, the first drain pipe is downward connected to the water supply pipe along a gravity direction. This enables water remaining in the heat exchanger to be discharged out by gravity along the first drain pipe when the clothes drier is stopped. As water is discharged out, an empty space inside the heat exchanger can serve as a margin space in preparation for an expanded volume of water. Accordingly, freeze damage of the heat exchanger due to an expanded volume of water during winter time is prevented.

Preferably, the freeze damage preventing unit includes a second drain pipe diverged from the water collect pipe, and a second valve configured to open and close the second drain pipe.

Preferably, for smooth drain, the second drain pipe is downward connected to the water collect pipe along a gravity direction. This enables water remaining in the heat exchanger to be discharged out by gravity along the second drain pipe when the clothes drier is stopped. As water is discharged out, an empty space inside the heat exchanger can serve as a margin space in preparation for an expanded volume of water. Accordingly, freeze damage of the heat exchanger due to an expanded volume of water during winter time is prevented.

Preferably, the freeze damage preventing unit includes a first drain pipe diverged from the water supply pipe, a first valve configured to open and close the first drain pipe, a second drain pipe diverged from the water collect pipe, and a second valve configured to open and close the second drain pipe.

Preferably, for smooth drain, the first drain pipe and the second drain pipe are downward connected to the water supply pipe and the water collect pipe along a gravity direction, respectively. This enables water remaining in the heat exchanger to be discharged out by gravity along the first and second drain pipes when the clothes drier is stopped. As water is discharged out, an empty space inside the heat exchanger can serve as a margin space in preparation for an expanded volume of water. Accordingly, freeze damage of the heat exchanger due to an expanded volume of water during winter time is prevented.

Preferably, the clothes drier further comprises a water tank configured to store water discharged from the first drain pipe or the second drain pipe, and a drain pump configured to drain water stored in the water tank through a pumping process. Here, the water tank stores condensing water collected by the heat exchanger, and water discharged from the first drain pipe or the second drain pipe is drained by the drain pump on the same path as condensing water.

Preferably, the first valve or the second valve is implemented as a ‘Normally Open Valve’ automatically opened when the clothes drier is stopped. Accordingly, when the clothes drier is stopped, the valve is automatically opened without an additional control, and thus water remaining in the heat exchanger is discharged out. As a result, the heat exchanger is protected from freeze damage.

As another example, the freeze damage preventing unit may be implemented as an air compressor installed at the water supply pipe. Preferably, the air compressor is configured to blow compressed air into the heat exchanger when the clothes drier is stopped. That is, when the clothes drier is stopped, the air compressor discharges out water remaining in the heat exchanger by blowing the water to the water collect pipe. Accordingly, the heat exchanger is protected from freeze damage.

To achieve these and other advantages and in accordance with the purpose of the present invention, as embodied and broadly described herein, there is also provided a clothes drier, comprising: a water-cooled type heat exchanger; and a freeze damage preventing unit configured to drain water remaining in the water-cooled type heat exchanger.

The freeze damage preventing unit includes a drain pipe downward connected to the water-cooled type heat exchanger along a gravity direction so that water remaining water in the water-cooled type heat exchanger can drop by gravity thus to be drained; and a valve installed at the drain pipe and configured to selectively open and close the drain pipe. Preferably, the valve is implemented as a ‘Normally Open Valve’ automatically opened when the clothes drier is stopped.

Preferably, the freeze damage preventing unit is implemented as an air compressor installed at the water supply pipe that supplies water to the water-cooled type heat exchanger, and configured to remove water remaining in the water-cooled type heat exchanger by blowing air.

Preferably, the freeze damage preventing unit is operated during winter time, and is configured to partially or completely drain water remaining in the water-cooled type heat exchanger when the clothes drier is stopped.

Preferably, the water-cooled type heat exchanger is installed at the clothes drier in plurality in number, and the clothes drier is implemented as a condensing type or a ductless type.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view of a clothes drier according to a first embodiment of the present invention;

FIG. 2 is a plane view of the clothes drier of FIG. 1;

FIG. 3 is an extracted plane view of a heat exchanger, a pipe unit, and a freeze damage preventing unit of FIG. 2;

FIG. 4 is an extracted perspective view of a heat exchanger, a pipe unit, and a freeze damage preventing unit of FIG. 2; and

FIG. 5 is a perspective view of a heat exchanger, a pipe unit, and a freeze damage preventing unit according to another embodiment of the present invention.

### DETAILED DESCRIPTION OF THE INVENTION

Reference will now be made in detail to the preferred embodiments of the present invention, examples of which are illustrated in the accompanying drawings Hereinafter, a clothes drier according to a first embodiment of the present invention will be explained in more detail with reference to the attached drawings.

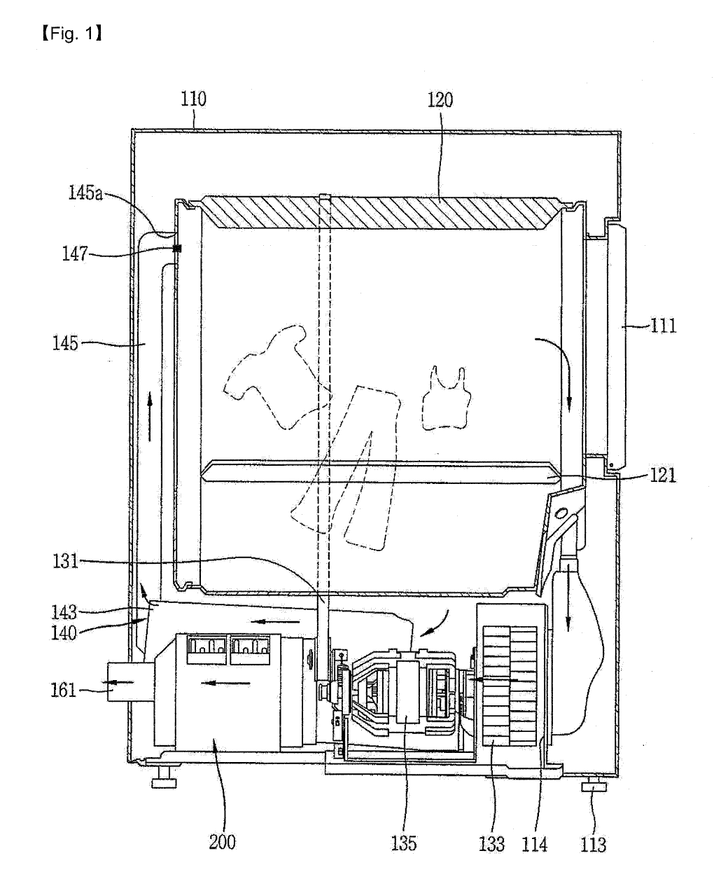

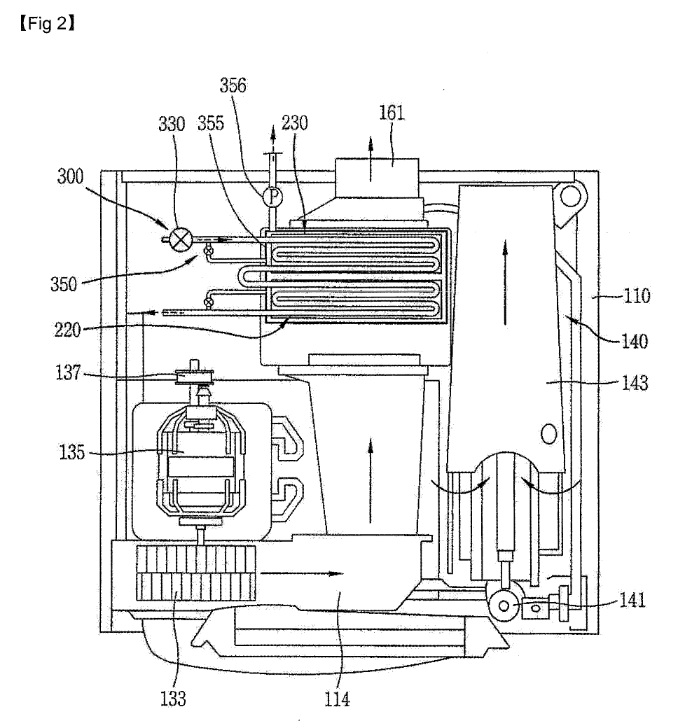

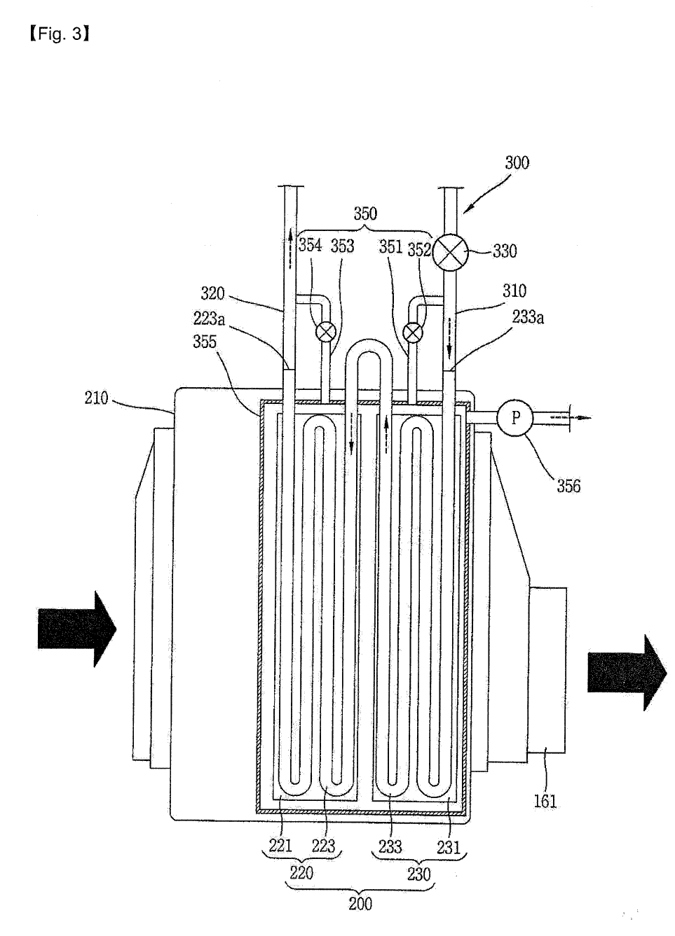

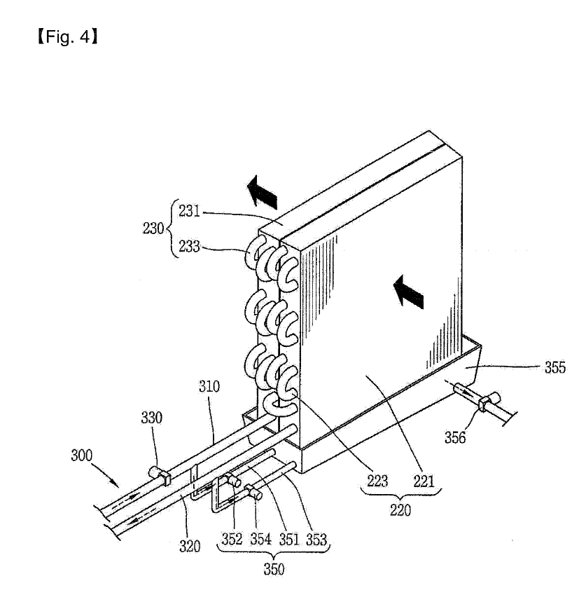

FIG. 1 is a schematic view of a clothes drier according to a first embodiment of the present invention, FIG. 2 is a plane view of the clothes drier of FIG. 1, FIG. 3 is an extracted plane view of a heat exchanger, a pipe unit, and a freeze damage preventing unit of FIG. 2, and FIG. 4 is an extracted perspective view of a heat exchanger, a pipe unit, and a freeze damage preventing unit of FIG. 2. The solid line arrow indicates air flow, and the dotted line arrow indicates water flow.

Referring to FIGS. 1 and 2, a body; the clothes drier according to a first embodiment of the present invention comprises: a body 110; a drum 120 rotatably installed at the body 110; a hot air supply unit 140 configured to supply hot air into the drum 120; a heat exchanger 200 configured to dehumidify air exhausted from the drum 120; a pipe unit 300 configured to supply water to the heat exchanger 200 and collect water from the heat exchanger; and a freeze damage preventing unit 350 installed on the pipe unit 300.

A door 111 through which clothes are introduced into the drum 120 is installed on a front surface of the body 110, and a foot 113 configured to support the body 110 is installed below the body 110. Inside the body 110, installed are a belt 131 configured to rotate the drum 120, a fan 133 disposed inside a circulation duct 114 that provides a blowing force by air inside the clothes, and a motor 135 configured to provide a driving force to the belt 131 and the fan 133. A pulley 137 configured to lock the belt 131 is installed on a rotation shaft of the motor 135. Here, the motor 135 may be configured in plurality in number so that a driving force can be provided to the belt 131 and the fan 133, respectively. At the circulation duct 114, installed is a filter (not shown) configured to filter lint such as nap and seam included in high temperature and high humid air exhausted from the drum 120.

The drum 120 is a box having an inner space to which an object to be dried, such as clothes, is introduced, and is provided with a plurality of lifters 121 therein configured to lift clothes. Hereinafter, an object to be dried will be called as clothes.

The hot air supply unit 140 includes a gas valve 141 configured to supply gas and shield gas supply, a gas combustor 143 configured to generate hot air by mixing gas exhausted from the gas valve 141 with external air and then by igniting the mixed air, a hot air supply duct 145 configured to connect the gas combustor 143 and the drum 120 to each other so that the generated hot air can be supplied to the drum 120, and a hot air temperature sensor 147 configured to detect a temperature of hot air introduced into the drum 120.

At the hot air supply unit 140, may be installed a flame rod extending from an edge of flame so as to detect a flame current and thus to indirectly judge an occurrence amount of carbon monoxide (CO) through a value of the flame current.

Based on a flame current measured by the flame rod, a controller (not shown) judges an occurrence amount of carbon monoxide (CO). Here, if the occurrence amount of carbon monoxide is increased enough to be harmful to a human body, gas supply is stopped and an alarm sound rings.

The gas combustor 143 is connected to the gas valve 141, thereby mixing gas exhausted from the gas valve 141 with external air and combusting the mixed gas. Then, generated heated is used to heat air.

Hot air generated by heating air is provided to the drum 120 through the hot air supply duct 145.

The hot air temperature sensor 147 is installed at a connection part 145a between the hot air supply duct 145 and the drum 120. The hot air temperature sensor 147 may be installed in plurality in number, and may be installed in the hot air supply duct 145.

If a temperature of air introduced into the drum 120 and detected by the hot air temperature sensor 147 exceeds a reference temperature (a temperature to prevent damage of clothes or to prevent fire occurrence), clothes damage occurs in case of the followings. A first case is that a volume of air flowing inside the clothes drier is decreased, e.g., air flow is prevented as lint is inserted into the filter. A second case is that air flow is not smooth due to too large amount of clothes inside the drum. In the second case, a duct connected to outside is blocked thus to decrease an air volume inside the clothes drier.

To prevent the above cases, the hot air supply unit 140 controls an amount of gas supplied to the gas combustor 143 by controlling the gas valve 141 according to an air volume. More concretely, when an air volume is decreased to cause a temperature detected by the hot air temperature sensor 147 to exceed a reference temperature, the gas valve 141 is partially or completely closed. Accordingly, an amount of gas supplied to the gas combustor 143 is decreased, or gas is prevented from being introduced into the gas combustor 143. Preferably, the gas valve 141 is implemented as a solenoid valve so as to sensitively adjust a gas injection amount.

Consequently, air temperature can be lowered by reducing an amount of heat supplied to air introduced into the drum 120 without frequently stopping gas combustion. Accordingly, clothes are prevented from being damaged, and the clothes drier has an enhanced stability.

Referring to FIGS. 2 and 3, the heat exchanger 200 includes a first heat exchanger 220 and a second heat exchanger 230 each received in a case 210. The heat exchanger may be implemented as one heat exchanger, or as three or more heat exchangers.

The first heat exchanger 220 includes fins 221 and tubes 223. And, the first heat exchanger 220 condenses high temperature and high humid air exhausted from the drum 120 by using water of a low temperature, thereby making the air be in a dried state. The first heat exchanger 220 is installed at the left side of the case 210 so as to be disposed at an outlet of the circulation duct 114 connected to the drum 120. Water included in the high temperature and high humid air is condensed thus to drop into a water tank 355. Then, the water stored in the water tank 355 is discharged out by a drain pump 356.

The fins 221 are formed as a plurality of metallic thin plates having an excellent conductivity are laminated to each other with a minute gap therebetween so as to vertically contact and pass high temperature and high humid air.

The tube 223 has water of a low temperature (22° C.) circulating therein, and penetrates the fins 221 in a zigzag manner.

Similar to the first heat exchanger 220, the second heat exchanger 230 includes fins 231 and tubes 233. And, the second heat exchanger 230 again condenses dehumidified air passing through the first heat exchanger 220 by using water of a low temperature in a heat exchange manner between the air and the water, thereby making the air be in a dried state.

The second heat exchanger 230 is installed at the right side of the case 210 so as to be disposed at an inlet of an exhaustion duct 161 of FIG. 1. Water included in the high temperature and high humid air is condensed thus to drop into the water tank 355. Then, the water stored in the water tank 355 is discharged out by the drain pump 356.

The fins 231 are formed as a plurality of metallic thin plates having an excellent conductivity are laminated to each other with a minute gap therebetween so as to vertically contact and pass high temperature and high humid air.

The tube 233 has water of a low temperature (22° C.) circulating therein, and penetrates the fins 231 in a zigzag manner.

The tube 223 of the first heat exchanger 220 is connected to the tube 233 of the second heat exchanger 230 at an intermediate point between the first heat exchanger 220 and the second heat exchanger 230.

Water supplied to an inlet 233a of the tube 233 of the second heat exchanger 230 passes through the second heat exchanger 230 and the first heat exchanger 220. Then, the water is discharged out through an outlet 223a of the tube 223 of the first heat exchanger 220. More concretely, once water is introduced into the inlet 233a of the tube 233 of the second heat exchanger 230, the water cools the fins 231 of the second heat exchanger 230 and the fins 221 of the first heat exchanger 220 via a supply valve 330 and the tubes 233, 223. Then, the water is discharge out through the outlet 223a of the tube 223 of the first heat exchanger 220.

The pipe unit 300 includes a water supply pipe 310 configured to supply water to the heat exchanger 200, a water collect pipe 320 configured to collect water from the heat exchanger 200, and a supply valve 330 configured to open and close the water supply pipe 310.

The water supply pipe 310 is connected to the inlet 233a of the tube 233 of the second heat exchanger 230, and supplies water to the first and second heat exchangers 220, 230.

The water collect pipe 320 is connected to the outlet 223a of the tube 223 of the first heat exchanger 220, and discharged out water exhausted from the first and second heat exchangers 220, 230.

The supply valve 330 is installed on the water supply pipe 310. And, the supply valve 330 supplies water to the first and second heat exchangers 220, 230 by opening the water supply pipe 310 when the clothes drier is operated, whereas stops the water supply to the first and second heat exchangers 220, 230 by closing the water supply pipe 310 when the clothes drier is stopped.

Referring to FIGS. 3 and 4, the freeze damage preventing unit 350 includes a first drain pipe 351 diverged from the water supply pipe 310, a first valve 352 configured to open and close the first drain pipe 351, a second drain pipe 353 diverged from the water collect pipe 320, and a second valve 354 configured to open and close the second drain pipe 353.

For smooth drain, one side of the first drain pipe 351 is downward connected to the water supply pipe 310 along a gravity direction, and another side thereof is connected to the water tank 355.

Preferably, the first valve 352 is implemented as a ‘Normally Open Valve’ automatically opened when the clothes drier is stopped. Accordingly, when the clothes drier is stopped, the first valve 352 is automatically opened without an additional control.

For smooth drain, one side of the second drain pipe 353 is downward connected to the water collect supply pipe 310 along a gravity direction, and another side thereof is connected to the water tank 355.

Preferably, the second valve 354 is implemented as a ‘Normally Open Valve’ automatically opened when the clothes drier is stopped. Accordingly, when the clothes drier is stopped, the second valve 354 is automatically opened without an additional control.

The clothes drier comprises a water tank 355 configured to store water drained from the first drain pipe 351 or the second drain pipe 353, and a drain pump 356 configured to drain water stored in the water tank 355 through a pumping process.

Here, the water tank 355 stores water drained from the first drain pipe 351 or the second drain pipe 353. The water tank 355 is disposed at a lower end of the heat exchanger 200, and stores condensing water dropped thereinto after being dehumidified by the heat exchanger 200.

The drain pump 356 drains water stored in the water tank 355 through a pumping process.

Hereinafter, the operation of the freeze damage preventing unit will be explained.

Referring to FIGS. 3 and 4, when the clothes drier starts to operate, the supply valve 330 is opened thus to sequentially supply water to the second heat exchanger 230 and the first heat exchanger 220 through the water supply pipe 310. Then, the water is discharged out through the water collect pipe 320.

When the clothes drier is stopped, the supply valve 330 is closed thus not to supply water to the second heat exchanger 230 and the first heat exchanger 220 any longer. At the same time, the first valve 352 and the second valve 354 are automatically opened.

Here, water remaining in the first and second heat exchangers 220 and 230 flows into the water tank 355 along the first and second pipes 351, 353 by gravity. Then, the water is discharged out by the drain pump 356.

As a result, an empty space obtained as 50% of water remaining at the first and second heat exchangers 220, 230 is discharged out can serve as a margin space in preparation for an expanded volume of water. This prevents freeze damage of the heat exchanger 200 due to an expanded volume of water occurring when the water undergoes phase change into ice.

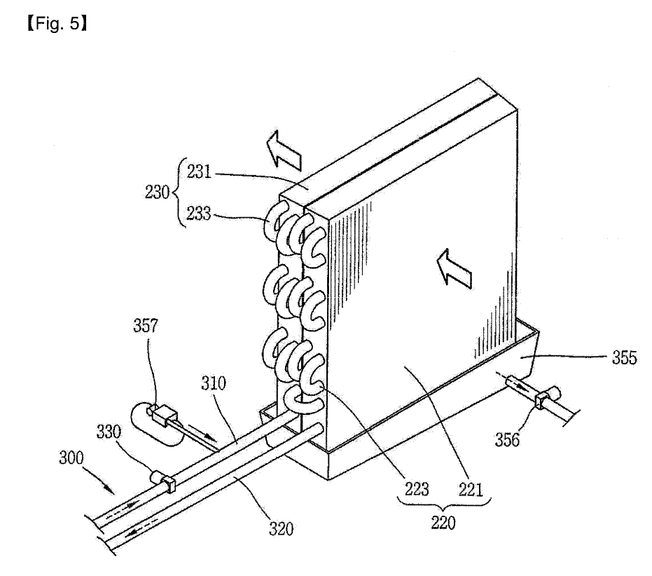

FIG. 5 is a perspective view of a heat exchanger, a pipe unit, and a freeze damage preventing unit according to another embodiment of the present invention. Referring to FIG. 5, the freeze damage preventing unit according to another embodiment of the present invention is implemented as an air compressor 357 installed on the water supply pipe 310.

Once the clothes drier starts to operate, the supply valve 330 is opened thus to sequentially supply water to the second heat exchanger 230 and the first heat exchanger 220 through the water supply pipe 310. Then, the water is discharged out through the water collect pipe 320.

Once the clothes drier is stopped, the supply valve 330 is closed thus not to supply water to the second heat exchanger 230 and the first heat exchanger 220 any longer.

Here, the air compressor 357 blows compressed air into the water supply pipe 310, thereby discharging out water remaining in the first and second heat exchangers 220, 230 by blowing the water to a direction of the water collect pipe 320. As a result, water remaining in the heat exchanger 200 is completely discharged out, thereby preventing freeze damage of the heat exchanger 200 due to an expanded volume of water during winter time.

As aforementioned, the clothes drier according to the present invention is provided with the freeze damage preventing unit configured to partially or completely discharge out water remaining in the heat exchanger after the clothes drier is stopped. Accordingly, freeze damage of the heat exchanger during winter time is prevented.

The foregoing embodiments and advantages are merely exemplary and are not to be construed as limiting the present invention. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A clothes drier, comprising:
a body;
a drum rotatably installed at the body;
a heat exchanger configured to dehumidify air exhausted from the drum;
a pipe unit configured to supply water to the heat exchanger and collect water from the heat exchanger; and
a freeze damage preventing unit installed on the pipe unit.

2. The clothes drier of claim 1, wherein the pipe unit comprises:
a water supply pipe configured to supply water to the heat exchanger;
a water collect pipe configured to collect water from the heat exchanger; and
a supply valve configured to open and close the water supply pipe.

3. The clothes drier of claim 2, wherein the freeze damage preventing unit comprises:
a first drain pipe diverged from the water supply pipe; and
a first valve configured to open and close the first drain pipe.

4. The clothes drier of claim 3, wherein the first drain pipe is downward connected to the water supply pipe along a gravity direction.

5. The clothes drier of claim 2, wherein the freeze damage preventing unit comprises:
a second drain pipe diverged from the water collect pipe; and
a second valve configured to open and close the second drain pipe.

6. The clothes drier of claim 5, wherein the second drain pipe is downward connected to the water collect pipe along a gravity direction.

7. The clothes drier of claim 2, wherein the freeze damage preventing unit comprises:
a first drain pipe diverged from the water supply pipe;
a first valve configured to open and close the first drain pipe;
a second drain pipe diverged from the water collect pipe; and
a second valve configured to open and close the second drain pipe.

8. The clothes drier of claim 7, wherein the first drain pipe and the second drain pipe are downward connected to the water supply pipe and the water collect pipe along a gravity direction, respectively.

9. The clothes drier of claim 7, further comprising:
a water tank configured to store water discharged from the first drain pipe or the second drain pipe; and
a drain pump configured to drain water stored in the water tank through a pumping process.

10. The clothes drier of claim 7, wherein the first valve or the second valve is opened when the clothes drier is stopped.

11. The clothes drier of claim 2, wherein the freeze damage preventing unit is implemented as an air compressor installed at the water supply pipe.

12. The clothes drier of claim 11, wherein the air compressor blows compressed air when the clothes drier is stopped.

13. A clothes drier, comprising:
a water-cooled type heat exchanger; and
a freeze damage preventing unit configured to drain water remaining in the water-cooled type heat exchanger.

14. The clothes drier of claim 13, wherein the freeze damage preventing unit comprises:
a drain pipe downward connected to the water-cooled type heat exchanger along a gravity direction so that water remaining water in the water-cooled type heat exchanger can drop by gravity to be drained; and
a valve installed at the drain pipe and configured to selectively open and close the drain pipe.

15. The clothes drier of claim 14, wherein the valve is implemented as a ‘Normally Open Valve’ automatically opened when the clothes drier is stopped.

16. The clothes drier of claim 13, wherein the freeze damage preventing unit is implemented as an air compressor installed at the water supply pipe that supplies water to the water-cooled type heat exchanger, and configured to remove water remaining in the water-cooled type heat exchanger by blowing air.

17. The clothes drier of claim 13, wherein the freeze damage preventing unit is configured to partially or completely drain water remaining in the water-cooled type heat exchanger when the clothes drier is stopped.

18. The clothes drier of claim 13, wherein the water-cooled type heat exchanger is installed in plurality in number.

19. The clothes drier of claim 13, wherein the clothes drier is implemented as a condensing type or a ductless type.
